(19) United States
(12) Patent Application Publication
(10) Pub. No.: US 2012/0170972 A1
(43) Pub. Date: Jul. 5, 2012

(54) CABINET ASSEMBLING APPARATUS AND CONNECTING PIECES

(76) Inventor: Xianmeng SONG, Shenzhen (CN)

(21) Appl. No.: 13/336,256

(22) Filed: Dec. 23, 2011

(30) Foreign Application Priority Data
Dec. 31, 2010 (CN) 201010620134.5

(51) Int. Cl. F16L 41/00; F16B 13/00

(52) U.S. Cl. 403/169; 403/292

(57) ABSTRACT

The present invention discloses a cabinet assembling apparatus and connecting pieces, relates to the field of communication devices, and is directed to solve the problem of the existing complex cabinet assembling and complex manufacturing process. The cabinet assembling apparatus includes a column and a beam, and further includes an angular three-way connecting piece, where a columnar boss and a half-encircled vertical wall are formed in at least one connection direction of the angular three-way connecting piece, and the column and the beam each are sleeved onto the columnar boss of the angular three-way connecting piece, and is pressed against the half-encircled vertical wall. The cabinet assembling apparatus according to the present invention has advantages of simple assembling, precise location, and reliable connection.

### CROSS-REFERENCE TO RELATED APPLICATIONS

This application claims priority to Chinese Patent Application No. 201010620134.5, filed on Dec. 31, 2010, which is hereby incorporated by reference in its entireties.

### FIELD OF THE INVENTION

The present invention relates to the field of communication devices, and in particular, to a cabinet assembling apparatus and connecting pieces.

### BACKGROUND OF THE INVENTION

In the field of modern computer and communications, cabinets are indispensable product. Profile steel cabinets are made of seamless steel pipes and beams. The framework of the existing profile steel cabinet is built by using the integrated framework soldering technique. The technique is to integrally solder the profile steel with the three-way connecting piece.

During implementation of the present invention, the inventor finds that the integrated soldering technique is complex and the soldering efficiency is low; and consequently, the existing cabinet assembling efficiency is low in the prior art.

### SUMMARY OF THE INVENTION

Embodiments of the present invention provide a cabinet assembling apparatus and connecting pieces with high assembling efficiency.

In order to solve the above problems, an embodiment of the present invention provides a cabinet assembling apparatus. The apparatus includes: an angular three-way connecting piece, where a columnar boss and a half-encircled vertical wall are formed in at least one connection direction; and a column and beam each are sleeved onto the columnar boss of the angular three-way connecting piece.

An embodiment of the present invention provides an angular three-way connecting piece, which has a columnar boss and a half-encircled vertical wall in each of three mutually vertical connection directions.

Another embodiment of the present invention provides a three-way connecting piece, which has a columnar boss and a half-encircled vertical wall in each of three connection directions, where among the three connection directions, an angle of 180 degrees is formed between two connection directions and an angle of 90 degrees is formed between another direction and the two directions.

Another embodiment of the present invention provides a two-way connecting piece, which has a columnar boss and a half-encircled vertical wall in each of two connection directions, where an angle of 180 degrees is formed between the two connection directions.

According to the cabinet assembling apparatus and connecting pieces provided in the present invention, the connecting pieces are used to connect a profile steel to an assemble cabinet, and the assembling efficiency is high.

### BRIEF DESCRIPTION OF THE DRAWINGS

FIG. 1 is a schematic diagram of assembling a profile steel framework according to an embodiment of the present invention;

FIG. 2 is a schematic diagram of a three-way connecting piece according to an embodiment of the present invention;

FIG. 3 is a schematic diagram of an axial direction of a three-way connecting piece according to an embodiment of the present invention;

FIG. 4 is a structural schematic diagram of a housing of a three-way connecting piece according to an embodiment of the present invention;

FIG. 5 is a schematic diagram of a three-way connecting piece sticking to a water-proof pad according to an embodiment of the present invention;

FIG. 6 is a cross-sectional diagram of a profile steel according to an embodiment of the present invention;

FIG. 7 is lateral diagram of a profile steel according to an embodiment of the present invention;

FIG. 8 is a front diagram of a profile steel according to an embodiment of the present invention;

FIG. 9 is a schematic front diagram of a pressing plate and a fastening screw according to an embodiment of the present invention;

FIG. 10 is a schematic rear diagram of a pressing plate and a fastening screw according to an embodiment of the present invention;

FIGS. 11 and 12 are diagrams illustrating the process of assembling profile steel frameworks according to an embodiment of the present invention;

FIG. 13 is a schematic diagram of a connecting location of a three-way connecting piece during an assembling process according to an embodiment of the present invention;

FIGS. 14 and 15 are cross-sectional diagrams along A-A direction as shown in FIG. 13 during an assembling process according to an embodiment of the present invention, where FIG. 14 shows a state when a screw starts to be fastened and FIG. 15 shows a state after a screw is fastened.

FIG. 16 is a schematic diagram of another three-way connecting piece according to an embodiment of the present invention; and

FIG. 17 is a schematic diagram of a two-way connecting piece according to an embodiment of the present invention.

### DETAILED DESCRIPTION OF THE EMBODIMENTS

The technical solutions of a cabinet assembling apparatus according to the present invention are described in detail with reference to accompanying drawings and specific embodiments.

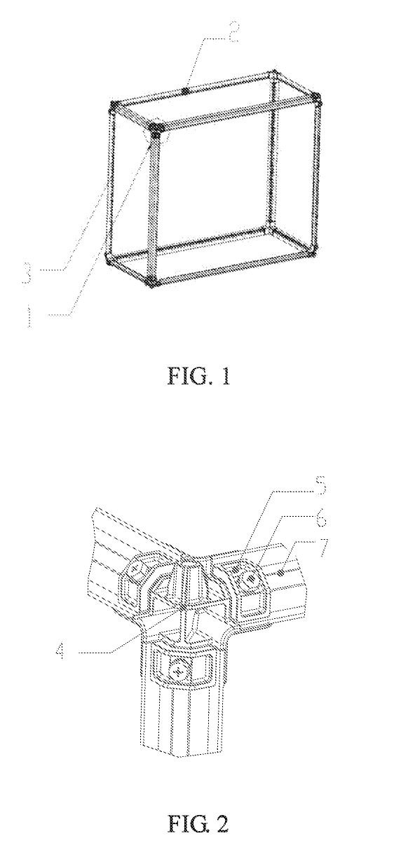

Referring to FIGS. 1, 2, and 4, a cabinet assembling apparatus according to an embodiment of the present invention includes: an angular three-way connecting piece 1, where a columnar boss 12 and a half-encircled vertical wall 9 that are formed in at least one connection direction; and a column 3 and a beam 2 each are sleeved onto the columnar boss 12 of the angular three-way connecting piece 1, and is pressed against the half-encircled vertical wall 9. The column 3 and the beam 2 are connected through the angular connecting piece 1. In this way, cabinet assembling is conveniently implemented and cabinet assembling efficiency is high.

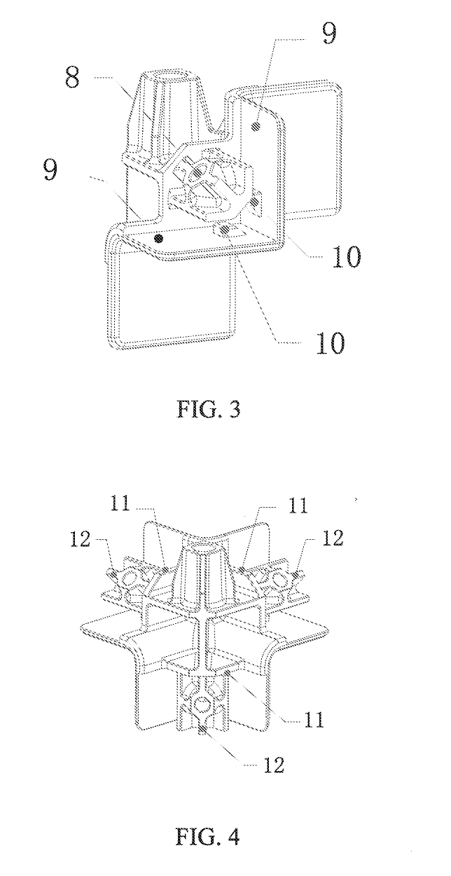

Referring to FIGS. 3 and 4, the angular connecting piece 1 and the half-encircled vertical wall 9 are parallel to the columnar boss 12; and an outer wall where the column 3 and the beam 2 are sleeved abuts against an inner wall of the half-encircled vertical wall 9 of the angular three-way connecting piece. The half-encircled vertical wall 9 may be either parallel to the axial direction of the columnar boss 12 or parallel to the outer side wall of the columnar boss 12. In this manner, the half-encircled vertical wall can better fix the column 3 and the beam 2, and can prevent crack of the column 3 and the beam 2 due to long-time use.

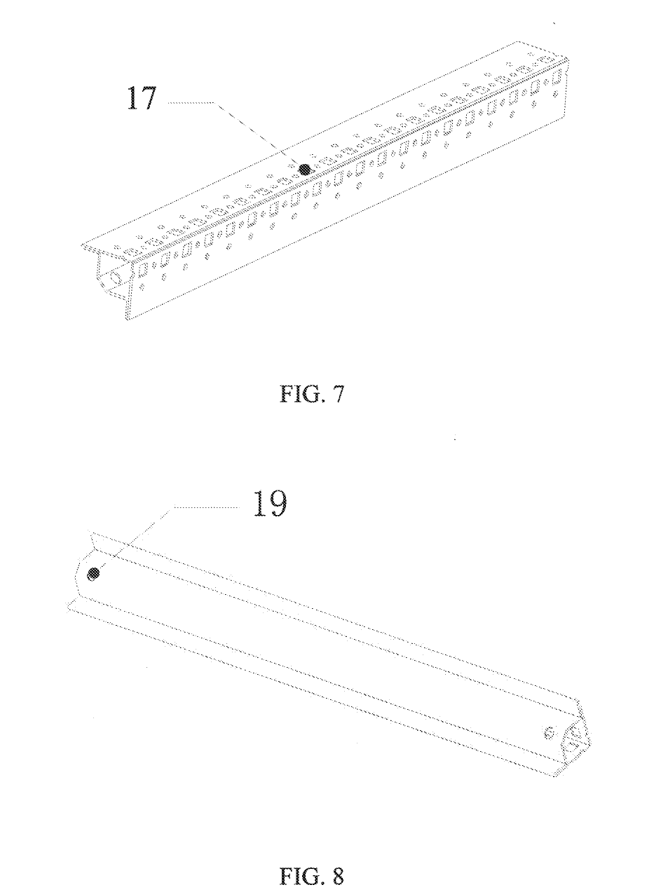

Referring to FIGS. 2, 3, and 7, the inner side of the half-encircled vertical wall of the angular connecting piece is provided with a limiting boss 10, and side walls of the column and the beam each are provided with a limiting hole 17; the limiting boss 10 is located in the limiting hole 17 of the column 3 and the beam 2 to fixedly secure the column 3 and the beam 2.

Referring to FIGS. 2 and 8, furthermore, the columnar boss of the angular connecting piece is connected to the column 3 and the beam 2 through a fixed structure. The fixed structure includes a threaded hole 8 disposed in the columnar boss, corresponding threaded holes 19 disposed in the column and the beam, and a screw 6 passing through the threaded holes 19 disposed in the column and the beam and the threaded hole 8 disposed in the columnar boss. The columnar boss 12 can be connected to the column 2 and the beam 3 securely by fastening the screw 6.

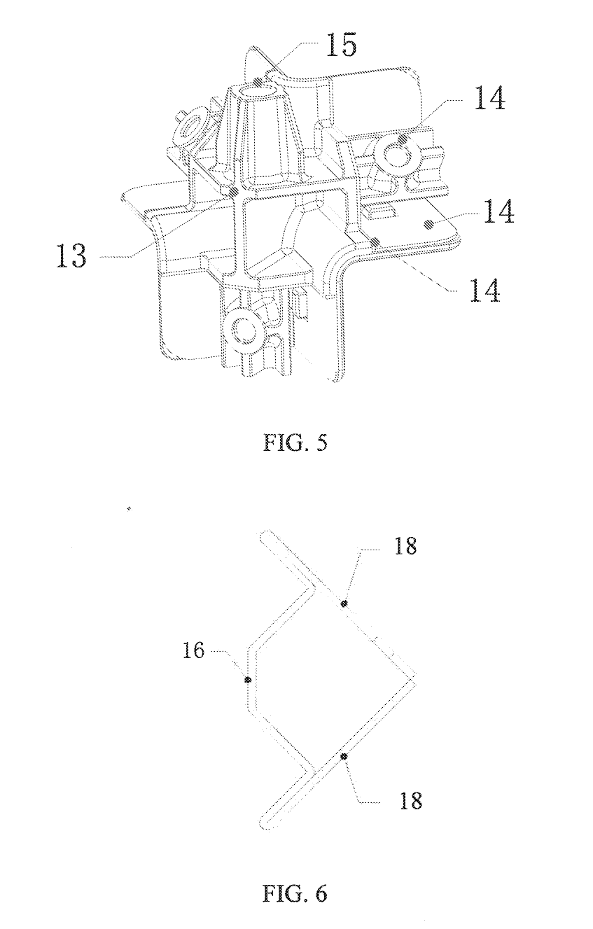

Referring to FIG. 5, the inner side of the half-encircled vertical wall of the angular connecting piece is set with a water-proof soft pad 14. The water-proof soft pad 14 is made of materials such as chloroprene foam, and is stuck to the body of the three-way connecting piece, so as to implement water-proof sealing of joints between the column, the beam, and the three-way connecting piece. If a joint between the column and the bean requires no water-proof sealing, the water-proof soft pad is not required to be stuck. If the water-proof soft pad is not used, water-proof glue may be applied on the joints between the column, the beam, and the body of three-way connecting piece for water-proof sealing.

Referring to FIG. 5, the angular three-way connecting piece further includes a lift threaded hole 15, so that a cabinet can be lifted and moved through the three-way connecting piece. As a preferred solution, the lift threaded hole is set in the reverse extension direction of a certain columnar boss, and lift threaded holes in multiple angular three-way connecting pieces are installed in the same direction so that the cabinet keeps balanced when being lifted.

The column 3 and the beam 2 are profile steel structures formed by bending plates; cross sections are polygon and inner cavities are formed. FIGS. 6 to 8 are schematic cross-sectional, lateral, and font diagrams of the profile steel applied in the present invention. The structure of the profile steel includes a front surface 16 and two side surfaces 18. The two side surfaces 18 of the profile steel are provided with square limiting holes 18 used for the limiting boss 10 of the three-way connecting piece to snap into. A circular threaded hole 19 is formed in the front surface 16 of the profile steel. When the profile steel is connected to the body of the three-way connecting piece, the front surface 16 of the profile steel is pressed from the front surface, so that a side surface 18 of the profile steel abuts against the half-encircled vertical wall 9 and the limiting boss 10 on a confining surface is restricted to snap rightly into the limiting hole 17 in the side surface 18 of the profile steel.

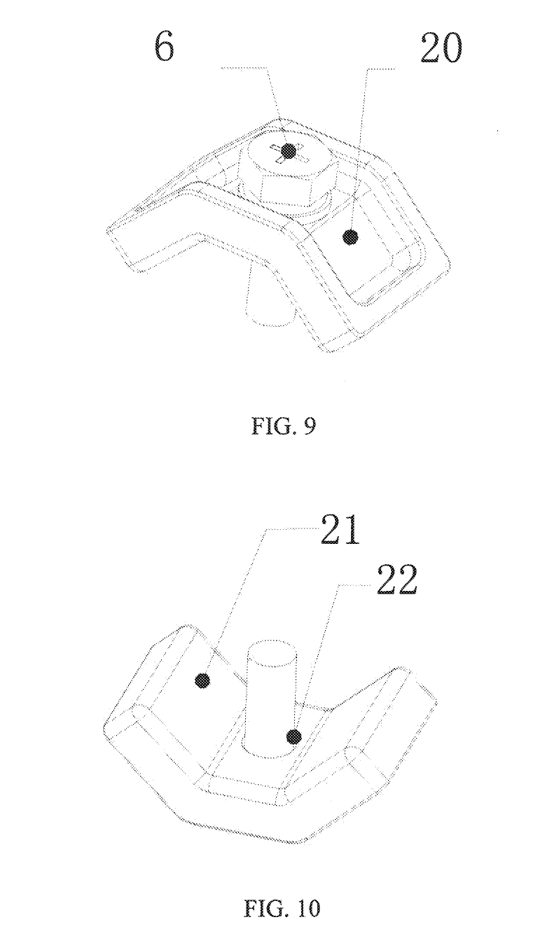

Referring to FIG. 2, according to the cabinet assembling apparatus provided in the present invention, furthermore, a pressing plate or pad 5 is disposed between the nut of the screw 6 and the column and/or the beam. The screw 6 passes through the pressing plate or pad 5, the threaded hole 19 disposed in the column 2 and/or the beam 2, and the threaded hole 8 disposed in the columnar boss. Referring to FIGS. 9 and 10, a circular threaded hole 22 in the pressing plate is a through-hole of the fastening screw 6. When the profile steel is connected to the housing of the three-way connecting piece, the fastening screw 6 passes through the through-hole 22 in the pressing plate and the threaded hole 19 in the front surface of the profile steel, and is screwed into the threaded hole 8 disposed in the housing of the three-way connecting piece. The pressing plate 5 is pressed by rotating the fastening screw 6, the inner side surface 22 of the pressing plate presses the front surface 16 of the profile steel, so that the side surface 18 of the profile steel tightly presses the half-encircled vertical wall 9 on the housing of the three-way connecting piece.

The following further describes how the three-way connecting piece is connected the profile steel.

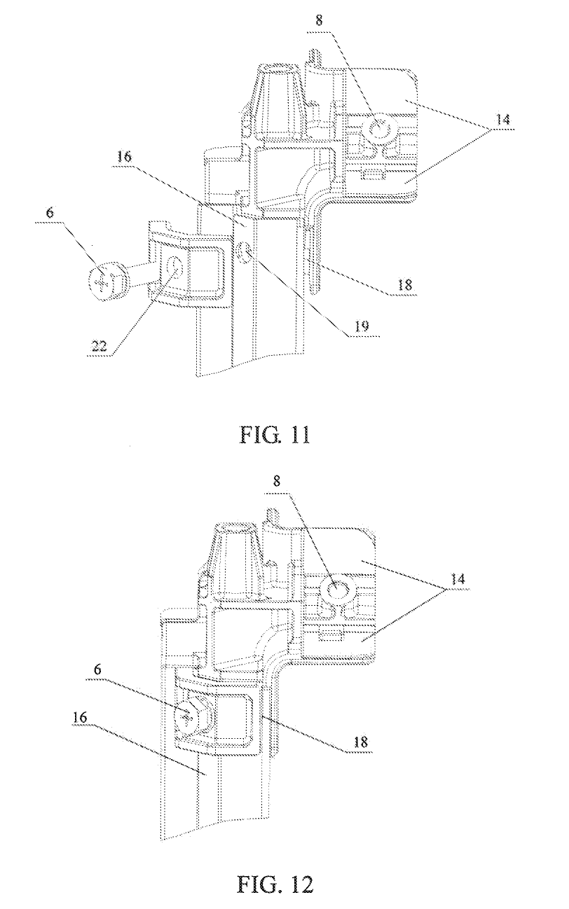

Referring to FIGS. 11 and 12, firstly, the water-proof soft pad 14 is stuck to the three-way connecting piece to implement water-proof sealing of the joint between the profile steel and the three-way connecting piece. Secondly, the profile steel is rightly inserted into the corresponding position of the three-way connecting piece, and an assembling pressing plate is pressed on the front surface 16 of the profile steel. Finally, the fastening screw 6 is used to pass through the through-hole 22 in the pressing plate and the threaded hole 19 in the front surface of the profile steel and is screwed into the threaded hole 8 in the housing of the three-way connecting piece. In this manner, the side surface 18 of the profile steel can be tightly pressed against a confining surface 9 of the profile steel.

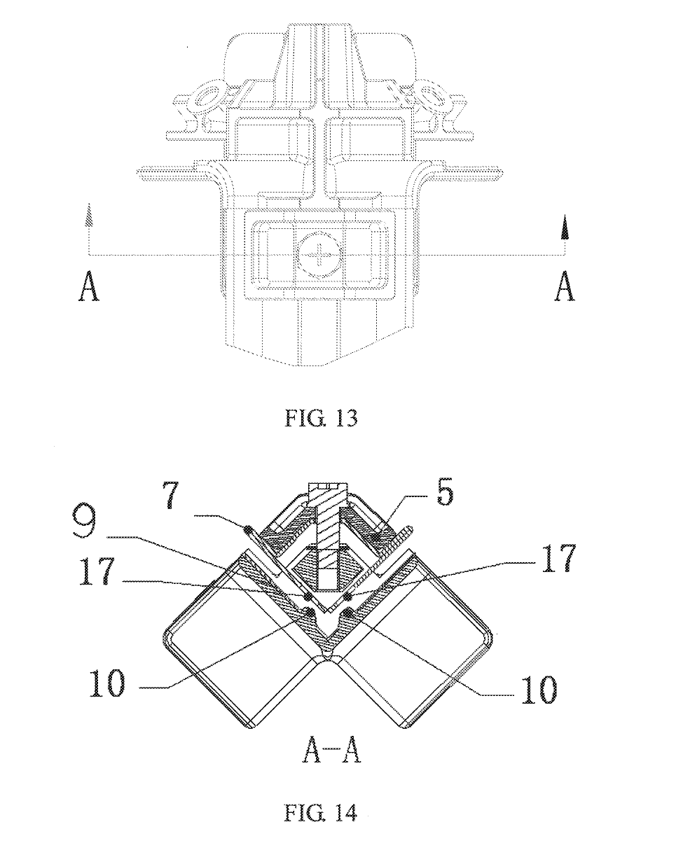

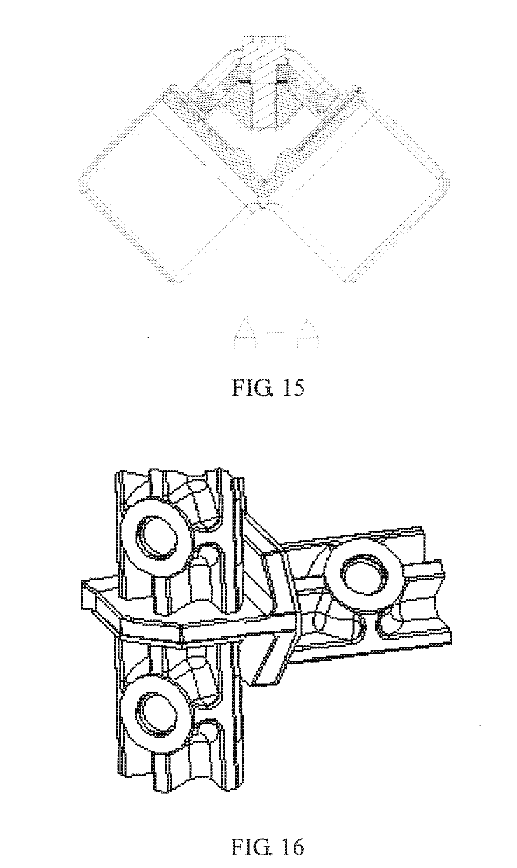

As shown in FIGS. 13-15, FIG. 13 is a schematic diagram of a connecting location of a three-way connecting piece during an assembling process according to an embodiment of the present invention; and FIGS. 14 and 15 are cross-sectional diagrams along A-A direction as shown in FIG. 13 during an assembling process according to an embodiment of the present invention, where FIG. 14 shows a state when a screw starts to be fastened and FIG. 15 shows a state after a screw is fastened.

During the process of tightening the pressing plate, the pressing plate 5 presses the profile steel 4 to move to the confining surface 9 of the profile steel of the housing of the three-way connecting piece, and at the same time, the limiting boss 10 is gradually inserted into a square hole 17 in the side surface of the profile steel. When the pressing plate 5 is completely tightened, the side surface of the profile steel is tightly pressed against the confining surface 9 of the profile steel of the housing of the three-way connecting piece, the limiting boss 10 also tightly snaps into the square hole 16 in the side surface of the profile steel, and then the front surface 16 of the profile steel is tightly pressed and confined by the pressing plate 5 and the screw 6.

Referring to FIG. 16, the cabinet assembling apparatus according to the present invention further includes a three-way connecting piece, where a columnar boss and a half-encircled vertical wall are disposed on each of three connection directions of the three-way connecting piece, where among the three connection directions, an angle of 180 degrees is formed between two connection directions and an angle of 90 degrees is formed between another connection direction and the two connection directions. The three-way connecting piece may be used to connect two shorter beams or columns and a support beam or a support column so as to securely support a cabinet; or when the length of the beams or columns is insufficient, the three-way connecting piece may be used to connect them to form a longer beam or column. According to the three-way connecting piece, the half-encircled vertical wall is parallel to the columnar boss. The half-encircled vertical wall may be either parallel to the axial direction of the columnar boss or parallel to the outer side wall of the columnar boss. For a specific structure, reference can be made to the half-encircled vertical wall of the angular three-way connecting piece mentioned above.

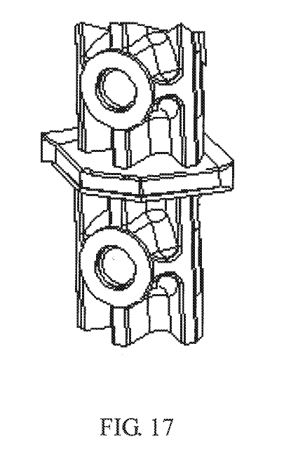

As shown in FIG. 17, the cabinet assembling apparatus according to the present invention further includes a two-way connecting piece, where a columnar boss and a half-encircled vertical wall are disposed on each of two connection directions, and an angle of 180 degrees is formed between the two connection directions. The three-way connecting piece may be used to connect two shorter beams or columns to form a beam or column with sufficient length. According to the two-way connecting piece, the half-encircled vertical wall is parallel to the columnar boss. The half-encircled vertical wall may be either parallel to the axial direction of the columnar boss or parallel to the outer side wall of the columnar boss. For a specific structure, reference can be made to the half-encircled vertical wall of the angular three-way connecting piece mentioned above.

As shown in FIG. 5, an embodiment of the present invention further provides an angular three-way connecting piece, where a columnar boss and a half-encircled vertical wall are formed in each of three mutually vertical connection directions of the angular three-way connecting piece. Components such as columns or beams are connected and assembled conveniently through the columnar boss and the half-encircled vertical wall. The specific structure of the angular three-way connecting piece in the embodiment is the same as that of the angular three-way connecting piece in the embodiment of the cabinet assembling apparatus mentioned above, which is not detailed here.

As shown in FIG. 16, an embodiment of the present invention provides a three-way connecting piece. A columnar boss and a half-encircled vertical wall are disposed on each of three connection directions of the three-way connecting piece, where among the three connection directions, an angle of 180 degrees is formed between two directions and an angle of 90 degrees is formed between another direction and the two directions. The half-encircled vertical wall is parallel to the columnar boss. The half-encircled vertical wall may be either parallel to the axial direction of the columnar boss or parallel to the outer side wall of the columnar boss. Components such as columns or beams are connected and assembled through the columnar boss and the half-encircled vertical wall. The specific structure of the three-way connecting piece in the embodiment is the same as that of the three-way connecting piece in the embodiment of the cabinet assembling apparatus mentioned above, which is not detailed here.

As shown in FIG. 17, an embodiment of the present invention further provides a two-way connecting piece. A columnar boss and a half-encircled vertical wall are disposed in each of two connection directions of the two-way connecting piece, where an angle of 180 degrees is formed between the two connection directions. The half-encircled vertical wall is parallel to the columnar boss. The half-encircled vertical wall may be either parallel to the axial direction of the columnar boss or parallel to the outer side wall of the columnar boss. Components such as columns or beams are connected and assembled conveniently through the columnar boss and the half-encircled vertical wall. The specific structure of the three-way connecting piece in the embodiment is the same as that of the three-way connecting piece in the embodiment of the cabinet assembling apparatus mentioned above, which is not detailed here.

Embodiments of the present invention apply to the cabinet assembling in the communications field, but the cabinet assembling apparatus and connecting pieces provided in the present invention are not limited to the application in the field. The method according to present invention may also apply to the cabinet assembling in other fields.

The technical solutions of the present invention implement assembling and manufacturing of the profile steel framework, solve the problem of complex soldering during integrated framework soldering and low assembling efficiency. In addition, the assembling solution has simple connection, and has the advantages of simple assembling and high assembling efficiency. Furthermore, the cabinet assembling apparatus provided in the present invention applies fixed structures, such as screws and threaded holes, to secure the beam, column, and the connecting piece. Therefore, the apparatus also has advantages of precise location and reliable connection.

In conclusion, the above are merely exemplary embodiments of the present invention. The protection scope of the present invention is not limited thereto. Variations or replacements readily derived by persons skilled in the prior art without departing from the technical scope of the present invention should fall within the protection scope of the present invention. Therefore, the protection scope of the present invention is subjected to the appended claims.

1. A cabinet assembling apparatus, comprising a column and a beam, wherein the cabinet assembling apparatus further comprises an angular three-way connecting piece; wherein a columnar boss and a half-encircled vertical wall are formed in at least one connection direction of the angular three-way connecting piece; and
the column and the beam each are sleeved onto the columnar boss of the angular three-way connecting piece, and is pressed against the half-encircled vertical wall.

2. The cabinet assembling apparatus according to claim 1, wherein the half-encircled vertical wall is parallel to the columnar boss; an outer wall where the column and/or the beam is sleeved onto the columnar boss of the angular three-way connecting piece abuts against an inner wall of the half-encircled vertical wall of the angular three-way connecting piece.

3. The cabinet assembling apparatus according to claim 2, wherein the inner wall of the half-encircled vertical wall of the angular three-way connecting piece is provided with a limiting boss; side surfaces of the column and the beam are set with limiting holes; and the limiting boss is located in a limiting hole.

4. The cabinet assembling apparatus according to claim 1, wherein the columnar boss of the angular three-way connecting piece is connected to the column and the beam through a fixed structure.

5. The cabinet assembling apparatus according to claim 4, wherein the fixed structure comprises a threaded hole disposed in the columnar boss, corresponding threaded holes disposed in the column and the beam, and a screw passing through the threaded holes disposed in the column and the beam and the threaded hole disposed in the columnar boss.

6. The cabinet assembling apparatus according to claim 5, wherein a press plate or a pad is disposed between a nut of the screw and the column and/or the beam.

7. The cabinet assembling apparatus according to claim 2, wherein a water-proof soft pad is disposed on the inner surface of the half-encircled vertical wall of the angular three-way connecting piece.

8. The cabinet assembling apparatus according to claim 1, wherein the angular three-way connecting piece is provided with a lift threaded hole, and the lift threaded hole is set in a reverse extension direction of any columnar boss.

9. The cabinet assembling apparatus according to claim 2, wherein the column and/or the beam is formed by bending a plate, cross sections of the column and/or the beam are polygons and inner cavities are formed;
the cavities accommodate the columnar boss of the angular three-way connecting piece; and
two side surfaces of the column and/or the beam abut against the inner wall of the half-encircled vertical wall of the angular three-way connecting piece, and the inner wall of the half-encircled vertical wall matches the shapes of the two side surfaces of the column and/or the beam.

10. The cabinet assembling apparatus according to claim 1, wherein the angular three-way connecting piece has three mutually vertical connection directions.

11. The cabinet assembling apparatus according to claim 10, further comprising another three-way connecting piece, wherein a columnar boss is formed in each of three directions of the another three-way connecting piece, an angle of 180 degrees is formed between two connection directions of the another three-way connecting piece, and an angle of 90 degrees is formed between another connection direction and the two connection directions.

12. The cabinet assembling apparatus according to claim 1, further comprising a two-way connecting piece, wherein a columnar boss is formed in each of two connection directions of the two-way connecting piece, an angle of 180 degrees is formed between the two connection directions of the two-way connecting piece.

13. An angular three-way connecting piece, wherein a columnar boss and a half-encircled vertical wall are formed in each of three mutually vertical connection directions of the angular three-way connecting piece.

14. The angular three-way connecting piece according to claim 13, wherein the halt-encircled vertical wall is parallel to an axial direction or outer side wall of the columnar boss.

15. The angular three-way connecting piece according to claim 14, wherein an inner wall of the half-encircled vertical is provided with a limiting boss.

16. The angular three-way connecting piece according to claim 14, wherein an inner wall of the half-encircled vertical is provided with a water-proof soft pad.

17. The angular three-way connecting piece according to claim 13, wherein the columnar boss is provided with a fixed structure.

18. The angular three-way connecting piece according to claim 13, wherein the three-way connecting piece is provided with a lift threaded hole, the lift threaded hole is set in a reverse extension direction of any columnar boss.

19. A three-way connecting piece, wherein a columnar boss and a half-encircled vertical wall are formed on each of three connection directions of the three-way connecting piece, wherein an angle of 180 degrees is formed between two connection directions among the three connection directions and an angle of 90 degrees is formed between another connection direction and the two connection directions.

20. The three-way connecting piece according to claim 19, wherein the halt-encircled vertical wall is parallel to an axial direction or outer side wall of the columnar boss.

21. A two-way connecting piece, wherein a columnar boss and a half-encircled vertical wall are formed on each of two connection directions, wherein an angle of 180 degrees is formed between the two connection directions.

22. The two-way connecting piece according to claim 21, wherein the halt-encircled vertical wall is parallel to an axial direction or outer side wall of the columnar boss.
